(19) United States
(12) Patent Application Publication
(10) Pub. No.: US 2012/0030175 A1
(43) Pub. Date: Feb. 2, 2012

(54) SYSTEM FOR OFFLOADING DATA ANALYIS OVERHEAD FROM A PRIMARY SITE TO A REMOTE SITE

(75) Inventors: Joel L. Masser, San Jose, CA (US); David C. Reed, Tucson, AZ (US); Max D. Smith, Tucson, AZ (US); Herbert Yee, Vail, AZ (US)

(73) Assignee: INTERNATIONAL BUSINESS MACHINES CORPORATION, Armonk, NY (US)

(21) Appl. No.: 12/844,763

(22) Filed: Jul. 27, 2010

(51) Int. Cl. G06F 12/16; G06F 17/30

(52) U.S. Cl. 707/640; 707/E17.005

(57) ABSTRACT

A method for reducing the data analysis overhead on a production system is disclosed herein. In one embodiment, such a method includes replicating production data from a primary site to a remote site. A control data set containing information for directing analysis of the production data is generated at the primary site and replicated to the remote site. At the remote site, the method includes analyzing the production data as directed by the control data set by making use of time on a CPU located at the remote site. Analysis may involve executing a diagnostic routine and/or generating a log file documenting the results of the analysis. A corresponding apparatus, system, and computer program product are also disclosed and claimed herein.

### BACKGROUND

1. Field of the Invention

This invention relates to apparatus and methods for analyzing data, and more particularly to apparatus and methods for reducing the data analysis overhead on production systems.

2. Background of the Invention

Computing systems produce data that is often susceptible error. For example, in network environments, where multiple users access the same production data, perhaps concurrently, the susceptibility to error is high. Analyzing the production data allows for the diagnosis and potentially correction of errors that may occur when the production data is generated or operations are performed thereon. Data analysis may be performed in various ways and at different times to ensure data integrity.

Data analysis, however, cannot be performed without costs. For example, when tracing is performed or when data is gathered through analysis techniques, the data is typically collected and analyzed on the same production system where the production applications are running. This generates additional overhead against the central processing unit (CPU) and direct access storage device (DASD) of the production system. The additional overhead is often prohibitive and may create an undesirable tradeoff between data integrity and processing speeds. Often, data integrity is sacrificed for higher processing speeds.

In many production systems, production data is often mirrored to a remote site using a data replication technology such as IBM's Peer-to-Peer Remote Copy (“PPRC”) or eXtended Remote Copy (“XRC”). The remote site to which the production data is mirrored often includes a CPU and DASD that are underutilized. However, presently a technology does not exist to take advantage of the remote CPU and DASD.

In view of the foregoing, what is needed is an apparatus and method for offloading data-analysis overhead from a production system at a primary site to a redundant system at a remote site. Ideally, such an apparatus and method would take advantage of underutilized resources, such as a CPU and DASD, at the remote site. Beneficially, such an apparatus and method would allow for analysis of production data without significantly compromising processing speeds on the production system.

### SUMMARY

The invention has been developed in response to the present state of the art and, in particular, in response to the problems and needs in the art that have not yet been fully solved by currently available apparatus and methods. Accordingly, the invention has been developed to provide apparatus and methods to reduce the data analysis overhead on a production system. The features and advantages of the invention will become more fully apparent from the following description and appended claims, or may be learned by practice of the invention as set forth hereinafter.

Consistent with the foregoing, a method for reducing the data analysis overhead on a production system is disclosed herein. In one embodiment, such a method includes replicating production data from a primary site to a remote site. A control data set containing information for directing analysis of the production data is generated at the primary site and replicated to the remote site. Among other data, the control data set may store locations for the replicated production data to be analyzed and/or indicate actions that need to be taken at the remote site during analysis. At the remote site, the method includes analyzing the production data as directed by the control data set by making use of time on a CPU located at the remote site. Analysis may involve executing a diagnostic routine and/or generating a log file documenting the results of the analysis.

A corresponding apparatus, system, and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram of one example of a network architecture where an apparatus, method, system and/or computer program product in accordance with the invention may be implemented;

FIG. 2 is a high-level block diagram showing one example of a data replication system for use with the present invention;

FIG. 3 is a high-level block diagram showing various modules that may be used to implement an apparatus and method in accordance with the invention;

FIG. 4 is a flow diagram showing one embodiment of a method for monitoring production data and writing a control data set at a primary site;

FIG. 5 is a flow diagram showing one embodiment of a method for replicating production data and control data from a primary site to a remote site; and

FIG. 6 is a flow diagram showing one embodiment of a method for analyzing production data at a remote site.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

As will be appreciated by one skilled in the art, the present invention may be embodied as an apparatus, system, method, or computer program product. Furthermore, the present invention may take the form of a hardware embodiment, a software embodiment (including firmware, resident software, microcode, etc.) configured to operate hardware, or an embodiment combining software and hardware aspects that may all generally be referred to herein as a “module” or “system.” Furthermore, the present invention may take the form of a computer-usable storage medium embodied in any tangible medium of expression having computer-usable program code stored therein.

Any combination of one or more computer-usable or computer-readable storage medium(s) may be utilized to store the computer program product. The computer-usable or computer-readable storage medium may be, for example but not limited to, an electronic, magnetic, optical, electromagnetic, infrared, or semiconductor system, apparatus, or device. More specific examples (a non-exhaustive list) of the computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, or a magnetic storage device. In the context of this document, a computer-usable or computer-readable storage medium may be any medium that can contain, store, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like, and conventional procedural programming languages, such as the “C” programming language or similar programming languages. Computer program code for implementing the invention may also be written in a low-level programming language such as assembly language.

The present invention may be described below with reference to flowchart illustrations and/or block diagrams of methods, apparatus, systems, and computer program products according to embodiments of the invention. It will be understood that each block of the flowchart illustrations and/or block diagrams, and combinations of blocks in the flowchart illustrations and/or block diagrams, can be implemented by computer program instructions or code. The computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be stored in a computer-readable storage medium that can direct a computer or other programmable data processing apparatus to function in a particular manner, such that the instructions stored in the computer-readable storage medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

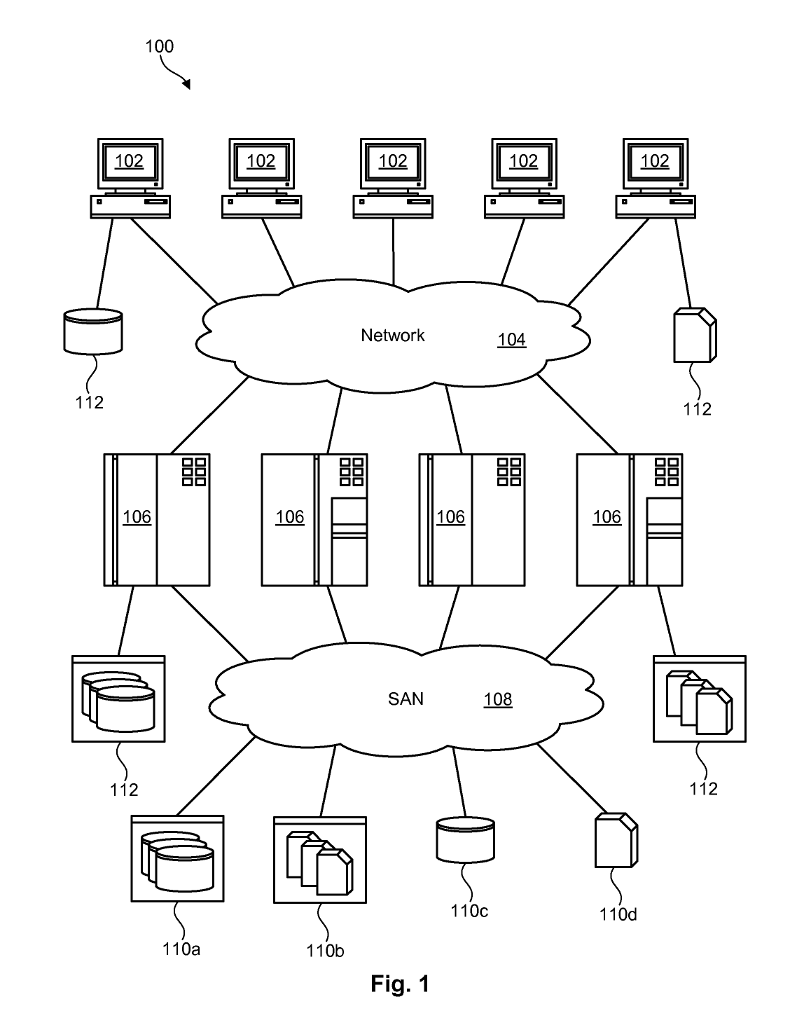

Referring to FIG. 1, one example of a network architecture 100 is illustrated. The network architecture 100 is presented to show one example of an environment where an apparatus, method, and/or computer program product in accordance with the invention may be implemented. The network architecture 100 is presented only by way of example and is not intended to be limiting. Indeed, the apparatus, methods, systems, and computer program products disclosed herein may be applicable to a wide variety of different computers, storage systems, and network architectures in addition to the illustrated network architecture 100 and components thereof.

As shown, the network architecture 100 includes one or more computers 102, 106 interconnected by a network 104. The network 104 may include, for example, a local-area-network (LAN) 104, a wide-area-network (WAN) 104, the Internet 104, an intranet 104, or the like. In certain embodiments, the computers 102, 106 may include both client computers 102 and server computers 106 (also referred to herein as “host systems 106”). In general, client computers 102 may initiate communication sessions, whereas server computers 106 (e.g., open system and/or mainframe servers 106) may wait for requests from the client computers 102. In certain embodiments, the computers 102 and/or servers 106 may connect to one or more internal or external direct-attached storage systems 112 such as arrays of hard disk drives or solid-state drives, tape libraries, tape drives, or the like. The computers 102, 106 and direct-attached storage systems 112 may communicate using protocols such as ATA, SATA, SCSI, SAS, Fibre Channel, or the like.

The network architecture 100 may, in certain embodiments, include a storage network 108 behind the servers 106, such as a storage-area-network (SAN) 108 or a LAN 108 (e.g., when using network-attached storage). This network 108 may connect the servers 106 to one or more storage systems 110, such as arrays 110a of hard-disk drives or solid-state drives, tape libraries 110b, individual hard-disk drives 110c or solid-state drives 110c, tape drives 110d, CD-ROM libraries, or the like. Connectivity through the network 108 may be provided by a switch, fabric, direct connection, or the like. Where the network 108 is a SAN, the servers 106 and storage systems 110 may communicate using a networking standard such as Fibre Channel (FC).

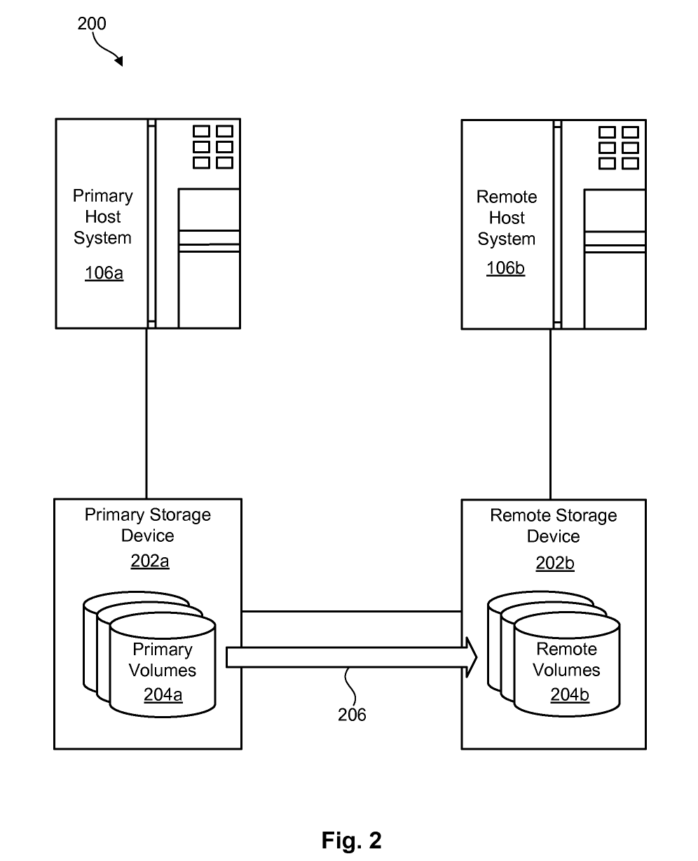

Referring to FIG. 2, one example of a data replication system 200 for use with the present invention is illustrated. Such a data replication system 200 may be implemented using the computing devices 102, 106, and or storage systems 110, 112, illustrated in FIG. 1, for example. As shown, two computing devices 106a, 106b, referred to herein as a primary host system 106a and a remote host system 106b, are communicatively coupled to a primary storage device 202a and a remote storage device 202b, respectively. The primary host system 106a and primary storage device 202a together may be considered a “production system,” whereas the remote host system 106b and remote storage device 202b together may be considered a “redundant system.” The primary storage device 202a stores data on one or more primary volumes 204a and the remote storage device 202b stores data on one or more remote volumes 204b.

As previously mentioned, in many production systems, production data is mirrored to a remote site using a data replication technology such as IBM's Peer-to-Peer Remote Copy (“PPRC”) or eXtended Remote Copy (“XRC”), or similar products produced by other vendors. In such a system, data from primary volumes 204a in a primary storage device 202a is replicated 206 to remote volumes 204b in a remote storage device 202b. Replication 206 may be carried out either synchronously or asynchronously depending on the application. The remote host system 106b and remote storage device 202b may be located some distance (e.g., several feet to thousands of miles) from the primary host system 106a and primary storage device 202a.

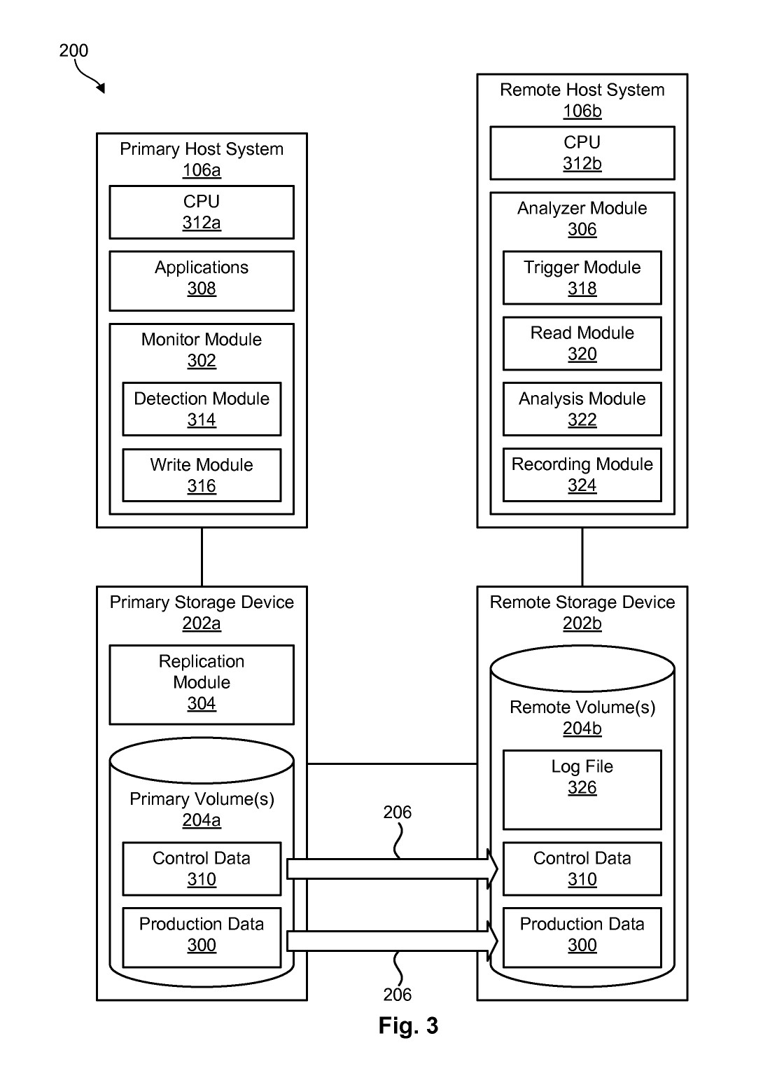

Referring to FIG. 3, to reduce data analysis overhead on the production system and more effectively utilize resources at the remote site, the system 200 may include one or more modules. These modules may be implemented in hardware, software or firmware executable on hardware, or a combination thereof. These modules are presented only by way of example and are not intended to be limiting. Indeed, alternative embodiments may include more or fewer modules than those illustrated. Furthermore, it should be recognized that, in some embodiments, the functionality of some modules may be broken into multiple modules or, conversely, the functionality of several modules may be combined into a single module or fewer modules. It should also be recognized that the modules are not necessarily implemented in the locations where they are illustrated. For example, some functionality shown in a host system 106 may actually be implemented in a storage device 202 and vice versa. Thus, the location of the modules is presented only by way of example and is not intended to be limiting.

As shown, in certain embodiments, the system 200 may include one or more of a monitor module 302, a replication module 304, and an analyzer module 306 distributed across various devices. In the illustrated example, the monitor module 302 may be included in the primary host system 106a; the replication module 304 may be included in the primary storage device 202a; and the analyzer module 306 may be included in the remote host system 106b. As will be explained in more detail hereafter, these modules 302, 304, 306 may be used to transfer data analysis overhead from the CPU 312a of the primary host system 106a to the CPU 312b of the remote host system 106b, as well as reduce the I/O load on the primary storage device 202a incurred when analyzing the data thereon.

In general, the monitor module 302 may monitor the primary host system 106a and production data 300 on the primary storage device 202a for events or conditions that would warrant conducting an analysis of the production data 300. A detection module 314 may be used to detect such events or conditions when they occur. Such events may include, for example, read and/or write actions taken with respect to a certain file (or data set) or a set of files (or data sets). The events may include any event where errors commonly occur or have a higher probability of occurring. Such events may include, for example, the extension of a data set to a new allocation, updates at the end of a file, and/or concurrent update activity from multiple users on a file or set of files. In some embodiments, external events such as SAN Volume Controller (SVC) calls or System Management Facility (SMF) records may be included among the events detected by the detection module 314. Other events, recognizable to those of skill in the art, that potentially compromise data integrity or are particularly error prone may be included among the events. In certain embodiments, the events that are recognized by the detection module 314 are user-customizable.

When the monitor module 302 detects such an event, a write module 316 may write information to a control data set 310 stored in the primary storage device 202a. This control data set 310 may store information needed or helpful to analyze the production data 300 associated with the event. For example, the write module 316 may write information (e.g., addresses or other location information) to the control data set 310 to identify the production data 300 that needs to be analyzed. The write module 316 may also write information to the control data set 310 indicating which actions (e.g., operations) need to be performed to analyze the production data 300. Other data, such as event types, time stamps, or the like, may also be written to the control data set 310 to aid in analyzing the production data 300.

The replication module 304 may be configured to replicate 206 data from one or more primary volume(s) 204a in the primary storage device 202a to one or more remote volume(s) 204b in the remote storage device 202b. More specifically, whenever applications 308 make changes to the production data 300 or the monitor module 302 makes changes to the control data 310, the replication module 304 may replicate these changes to the remote storage device 202b. In this way, the remote storage device 202b maintains a consistent copy of the control data 310 and the production data 300 located at the primary storage device 202a. In selected embodiments, the replication module 304 utilizes a data replication technology such as IBM's Peer-to-Peer Remote Copy (“PPRC”) or eXtended Remote Copy (“XRC”), although other similar data replication technologies by the same or other vendors may also be used.

An analyzer module 306, located on the remote host system 106b, may be configured to analyze the production data 300, located on the remote storage device 202b, in accordance with the information contained in the control data set 310. To accomplish this, the analyzer module 306 includes one or more of a trigger module 318, a read module 320, an analysis module 322, and a recording module 324. The trigger module 318 may be configured to trigger execution of the analyzer module 306 when the control data set 310 on the remote storage device 202b is updated. When an update is detected, a read module 320 may read the control data set 310 to retrieve instructions or other information needed to analyze the production data 300. The control data set 310 may include location information for the production data 300 to be analyzed and/or information about actions that need to be performed on the production data 300. In some embodiments, the control data 310 includes information about events that have occurred and the analyzer module 306 itself determines which actions or operations need to be performed on the production data 300 in response to the events. The read module 320 may also read relevant portions of the production data 300 so that it can be analyzed by the analysis module 322.

The analysis module 322 may analyze relevant portions of the production data 300 as directed by the control data set 310. In certain embodiments, the analysis module 322 contains routines for analyzing the production data 300 to address different types of events. In such embodiments, the analysis module 322 may carry out the appropriate routines (e.g., traces, diagnostic routines, data collection routines, etc.) on the relevant portions of the production data 300. In general, the analysis module 322 may carry out routines to determine whether an error occurred, determine the nature of an error that has occurred, or otherwise verify the integrity of the production data 300. In selected embodiments, the analysis module 322 is configured to retrieve instructions from the control data set 310 and carry out those instructions on the production data 300. In certain embodiments, the events that trigger execution of the analysis module 322 as well as the actions that are taken in response to the events are user-customizable.

Once the analysis module 322 has analyzed the relevant portions of the production data 300, a recording module 324 may record the results of the analysis in a log file 326. The results may include a diagnostic report, a trace, or other desired data. The log file 326 may also contain a history of changes to certain portions of the production data 300, such as times when the production data 300 changed and/or the events that were responsible for the changes.

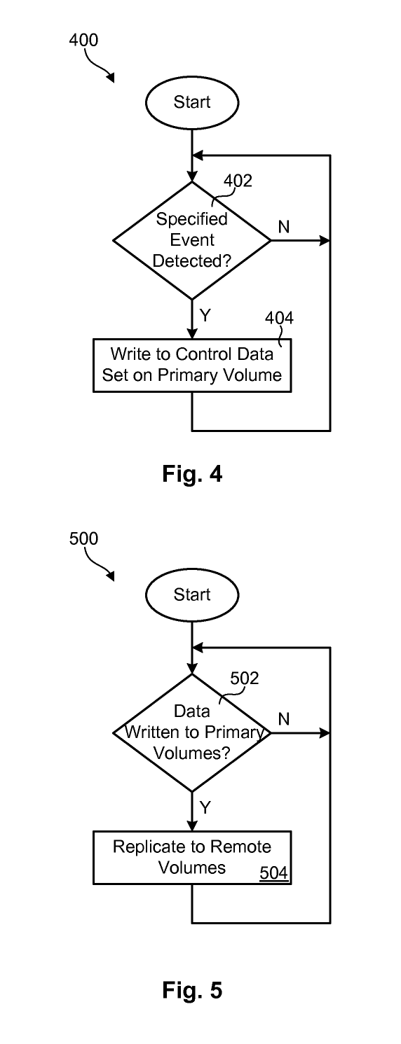

Referring to FIG. 4, one embodiment of a method 400 for monitoring production data 300 and writing a control data set 310 at a primary site is illustrated. Such a method 400, for example, may be executed by the monitor module 302 illustrated in FIG. 3. As shown, the method 400 initially determines 402 whether a specified event is detected at the primary site. The event may include any of the events discussed in associated with FIG. 3. These events may include those events that commonly incur errors, increase the probability of incurring errors, have the potential to compromise data integrity, or that otherwise cause concern to warrant analyzing the production data 300.

If a specified event is detected 402, the method 400 writes 404 to a control data set 310 on a primary volume 204a. The write operation 404 may write information relevant to the specified event that is necessary or useful to analyze the production data 300 at the remote site. The information may include information regarding the location of relevant production data 300 at the remote site, actions that need to be performed on the production data 300, information describing the event type, time stamps, or the like. After the write operation 404, the method 400 continues to monitor for additional events so that the control data set 310 is continually updated.

Referring to FIG. 5, one embodiment of a method 500 for replicating the production data 300 and control data 310 to a remote site is illustrated. Such a method 500 may be executed by the replication module 304 discussed in association with FIG. 3. As shown, the method 500 initially determines 502 whether data has been written to a primary volume 204a configured in a mirroring relationship with one or more remote volumes 204b. The data may be production data 300, control data 310, or both. If data is written to the primary volume 204b, the method 500 replicates 504 the data to one or more remote volumes 204b. The replication operation 504 may be performed synchronously or asynchronously using replication technologies such as PPRC or XRC, as described above in association with FIG. 2. After the replication operation 504 is complete, the method 500 continues to determine 502 whether data has been written to the primary storage volumes 204b so that the control data set 310 and production data 300 are continually updated.

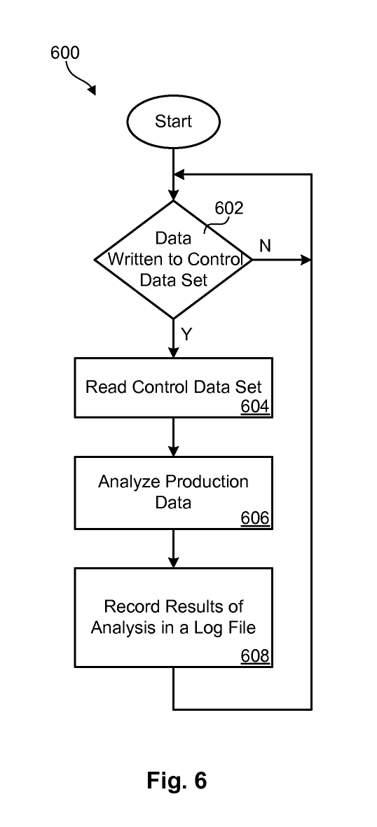

Referring to FIG. 6, one embodiment of a method 600 for analyzing production data 300 replicated to a remote site is illustrated. Such a method 600 may be executed by the analyzer module 306 discussed in association with FIG. 3. As shown, the method 600 initially determines 602 whether data is written to a control data set 310 in the remote storage volume 204b. If data is written to the control data set 310, the method 600 continues by reading 604 the control data set 310. Depending on the embodiment, the read operation 604 (and operations 606, 608 occurring after the read operation 604) may be executed either immediately when data is written to the control data set 310 or at a specified time or schedule after data is written to the control data set 310.

The method 600 then analyzes 606 the production data 300, located on the remote storage device 202b, in accordance with the information contained in the control data set 310. This may include performing various routines to analyze the production data 300. For example, trace routines, diagnostic routines, data collection routines, or the like, may be performed on relevant portions of the replicated production data 300 during the analysis. These routines may determine whether an error occurred, determine the nature of an error that has occurred, or verify the integrity of the production data 300. Once the analysis has been performed, the method 600 may record 608 the results of the analysis in a log file 326 or other data store. The log file 326 may be accessed by a system administrator or other individual to examine the results of the analysis.

The flowcharts and block diagrams in the Figures illustrate the architecture, functionality, and operation of possible implementations of systems, methods, and computer-usable media according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, the blocks may sometimes be executed in reverse, or the blocks may be executed in an alternate order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for offloading data-analysis overhead from a primary site to a remote site, the method comprising:
replicating production data from a primary site to a remote site, the remote site comprising a central processing unit (CPU);
generating, at the primary site, a control data set containing information for directing analysis of the production data;
replicating the control data set from the primary site to the remote site; and
analyzing the production data, replicated from the primary site to the remote site, as directed by the control data set by making use of time on the CPU at the remote site.

2. The method of claim 1, further comprising:
monitoring, at the primary site, activity related to the production data for at least one pre-defined event; and
including information related to the at least one pre-defined event in the control data set;

3. The method of claim 1, wherein the control data set stores locations for at least a portion of the replicated production data to be analyzed.

4. The method of claim 1, wherein the control data set indicates what actions need to be taken at the remote site upon analyzing the replicated production data.

5. The method of claim 1, wherein analyzing the replicated production data comprises executing at least one diagnostic routine on the replicated production data.

6. The method of claim 1, further comprising generating a log file at the remote site with output generated from analyzing the replicated production data.

7. The method of claim 6, wherein the log file contains a history of at least a portion of the replicated production data.

8. An apparatus for offloading data-analysis overhead from a primary site to a remote site, the apparatus comprising:
a monitor module to monitor production data at a primary site, and write to a control data set when at least one pre-defined event associated with the production data is detected at the primary site;
a replication module to replicate the production data and the control data set from the primary site to the remote site; and
an analyzer module to analyze the production data, replicated from the primary site to the remote site, as directed by the control data set by making use of time on a CPU at the remote site.

9. The apparatus of claim 8, wherein the control data set stores locations for at least a portion of the replicated production data to be analyzed by the analyzer module.

10. The apparatus of claim 8, wherein the control data set indicates what actions need to be taken on the replicated production data at the remote site.

11. The apparatus of claim 8, wherein the at least one pre-defined event comprises an event selected from the group consisting of extending a data set to a new allocation, updating the end of a file, and concurrently updating a file by multiple users.

12. The apparatus of claim 8, wherein the analyzer module executes at least one diagnostic routine on the replicated production data.

13. The apparatus of claim 8, wherein the analyzer module generates a log file at the remote site documenting the results of the analysis.

14. The apparatus of claim 13, wherein the log file contains a history of at least a portion of the replicated production data.

15. A system for offloading data-analysis overhead from a primary site to a remote site, the system comprising:
a primary site comprising a first central processing unit (CPU);
a remote site comprising a second CPU;
a monitor module to monitor production data at a primary site, and write to a control data set when at least one pre-defined event associated with the production data is detected at the primary site;
a replication module to replicate the production data and the control data set from the primary site to the remote site;
an analyzer module to analyze the production data, replicated from the primary site to the remote site, as directed by the control data set by making use of time on the second CPU.

16. The system of claim 15, wherein the control data set stores locations for at least a portion of the replicated production data to be analyzed by the analyzer module.

17. The system of claim 15, wherein the control data set indicates what actions need to be taken at the remote site upon analyzing the replicated production data.

18. The system of claim 15, wherein the analyzer module executes at least one diagnostic routine on the replicated production data.

19. The system of claim 15, wherein the analyzer module generates a log file at the remote site documenting the results of the analysis.

20. The system of claim 15, wherein the log file contains a history of at least a portion of the replicated production data.

21. A computer program product for offloading data-analysis overhead from a primary site to a remote site, the computer program product comprising a computer-usable storage medium having computer-usable program code embodied therein, the computer-usable program code comprising:
computer-usable program code to monitor production data at a primary site, and write to a control data set when at least one pre-defined event associated with the production data is detected at the primary site;
computer-usable program code to replicate the production data and the control data set from the primary site to a remote site; and
computer-usable program code to analyze the production data, replicated from the primary site to the remote site, as directed by the control data set by making use of time on a central processing unit at the remote site.

22. The computer program product of claim 21, wherein the control data set stores locations for at least a portion of the replicated production data to be analyzed.

23. The computer program product of claim 21, wherein the control data set indicates what actions need to be taken at the remote site upon analyzing the replicated production data.

24. The computer program product of claim 21, wherein analyzing the production data comprises executing at least one diagnostic routine on the production data.

25. The computer program product of claim 21, further comprising computer-usable program code to generate a log file documenting the results of the analysis.
